(19) United States
(12) Patent Application Publication
(10) Pub. No.: US 2021/0282002 A1
(43) Pub. Date: Sep. 9, 2021

(54) UE LIMITATIONS FOR DUPLICATION

(71) Applicant: Nokia Technologies Oy, Espoo (FI)

(72) Inventors: Benoist SÈBIRE, Tokyo (JP); Dawid KOZIOL, Wroclaw (PL); Ping-Heng KUO, London (GB); Tero HENTTONEN, Espoo (FI)

(21) Appl. No.: 17/186,185

(22) Filed: Feb. 26, 2021

Related U.S. Application Data
(60) Provisional application No. 62/984,597, filed on Mar. 3, 2020.

(51) Int. Cl. H04W 8/24; H04W 36/00; H04W 28/02

(52) U.S. Cl. CPC H04W 8/24; H04W 28/0268; H04W 36/0055

(57) ABSTRACT

In some example embodiments, there may be provided a method. The method may include generating, by a user equipment, capability information including an indication of the user equipment being able to be configured with additional radio link control entities that are not accounted for fully or partially towards a limit for the user equipment's capability for data radio bearers or for radio link control entities; and sending, by the user equipment, the capability information including the indication to a base station.

### FIELD

The subject matter described herein relates to cellular networks.

### BACKGROUND

As the cellular system including the 5G network supports an increasing number of devices and services including applications with a wide range of use cases and diverse needs with respect to bandwidth, latency, and reliability requirements, the cellular system may need to support certain services including those with increased reliability and/or decreased latency. An example of such as service is ultrareliable and/or low latency communications (URLLC). URLLC may provide reliable radio access with low or ultra-low latency. URLLC may be used in a variety of settings including machine-to-machine communications, for example.

### SUMMARY

In some example embodiments, there may be provided a method. The method may include generating, by a user equipment, capability information including an indication of the user equipment being able to be configured with additional radio link control entities that are not accounted for fully or partially towards a limit for the user equipment's capability for data radio bearers or for radio link control entities; and sending, by the user equipment, the capability information including the indication to a base station.

In some variations, one or more of the features disclosed herein including the following features can optionally be included in any feasible combination. The additional radio link control entities may be for packet duplication and/or a handover. The user equipment may receive a configuration for an additional quantity of radio link control entities exceeding the limit. The user equipment may utilize the configuration received from the network as a valid configuration. At least a portion of the additional quantity of radio link control entities may be accounted for as a partial radio link control entity and/or a partial data radio bearer. The indication may include information that the additional radio link control entities are partially counted towards the limit. The indication may include information that radio link control entities are not counted, or are partially counted, towards the limit, when the radio link control entities are in a deactivated state or have not been scheduled for transmission. The indication may include information that radio link control entities are not counted, or are partially counted, towards the limit, when the radio link control entities are in an unacknowledged mode. The indication may include information that radio link control entities in an acknowledged mode are not counted, or are partially counted, towards the limit

In some example embodiments, there may be provided a method. The method may include operating, by a user equipment, at least one additional radio link control entity, the at least one additional radio link control entity exceeding a limit for the user equipment's capability for data radio bearers or for radio link control entities; and stopping, by the user equipment, use of the at least one additional radio link control entity.

In some variations, one or more of the features disclosed herein including the following features can optionally be included in any feasible combination. The stopping of the use may include halting a logical channel mapped to the at least one additional radio link control entity. The stopping of the use may include deactivating the at least one additional radio link control entity. The user equipment may send a first user equipment capability indicating a first quantity of radio link control entities that the user equipment may configure with a service guarantee. The user equipment may send a second user equipment capability indicating a second quantity of radio link control entities that the user equipment may configure without the service guarantee such that the user equipment is allowed to halt or deactivate the at least one additional radio link control entity, the second quantity of radio link control entities including the at least one additional radio link control entity. The user equipment may configure the second quantity of radio link control entities including the at least one additional radio link control entity. The second quantity of radio link control entities may be used for packet duplication and/or a handover. The at least one additional radio link control entity may be halted or deactivated based on a selection rule. The selection rule may be based on one or more of the following factors: the at least one additional radio link control entity being associated to at least one data radio bearer mapped to a QoS flow with a QoS flow identifier; a mode of the at least one additional radio link control entity; the at least one additional radio link control entity having a logical channel mapping to a serving cell in a frequency range or a cell group; an instantaneous radio channel quality of a serving cell for the logical channel mapped to the at least one additional radio link control entity; a mapping restriction for a logical channel mapped to the at least one additional radio link control entity; an index; and a sequence number. The selection rule may be based on a priority of the at least one additional radio link control entity. The selection rule may be based on switching among a plurality of the radio link control entities. The selection rule may be configured by a base station. The user equipment may sent to the network a report indicating whether the limit has been reached.

In some example embodiments, there may be provided a method. The method may include receiving capability information including an indication of a user equipment being able to be configured with at least one additional radio link control entity that is not accounted for fully or partially towards a limit for the user equipment's capability for data radio bearers or for radio link control entities; and operating the at least one additional radio link control entity, the at least one additional radio link control entity exceeding a limit for the user equipment's capability for data radio bearers or for radio link control entities.

In some variations, one or more of the features disclosed herein including the following features can optionally be included in any feasible combination. A first user equipment capability may be received indicating a first quantity of radio link control entities that the user equipment may configure with a service guarantee. A second user equipment capability may be received indicating a second quantity of radio link control entities that the user equipment may configure without the service guarantee such that the user equipment is allowed to halt or deactivate the at least one additional radio link control entity, the second quantity of radio link control entities including the at least one additional radio link control entity. A report may be received indicating whether the limit has been reached.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIGS. 1A-1B depict examples of radio link control entities, in accordance with some example embodiments;

FIG. 2 depicts an example of a signaling flow between a user equipment and a network, in accordance with some example embodiments;

FIG. 3 depicts another example of a signaling flow between a user equipment and a network, in accordance with some example embodiments;

FIG. 4 depicts an example of a network node, in accordance with some example embodiments; and

FIG. 5 depicts an example of an apparatus, in accordance with some example embodiments.

Like labels are used to refer to same or similar items in the drawings.

### DETAILED DESCRIPTION

Packet duplication may be provided for Ultra-Reliable and Low Latency Communications (URLLC) services as described in, for example, 3GPP TS 38.300, 3rd Generation Partnership Project; Technical Specification Group Radio Access Network; NR; NR and NG-RAN Overall Description; Stage 2 (Release 15) as well as subsequent versions, hereinafter 3GPP TS 38.300. When packet duplication is configured for a radio bearer by radio resource control (RRC), at least one secondary radio link control (RLC) entity may be added to the radio bearer to handle the duplicated packet data convergence protocol (PDCP) protocol data units (PDUs).

Packet duplication at PDCP may include submitting the same PDCP PDUs multiple times, once to the primary RLC entity and provide the duplicate to at least one secondary RLC entity. With multiple independent transmission paths between at least the user equipment (UE) and the base station (e.g., the eNB, gNB, and the like), packet duplication may increase reliability and may reduce latency, both of which may be beneficial for URLLC services.

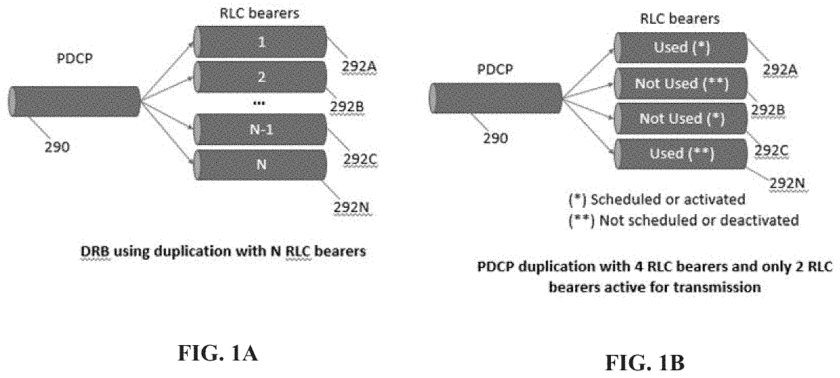

In Release 15, packet duplication allows using two transmission paths. This packet duplication may be enhanced in Release 16 to use up to four transmission paths by allowing up to four RLC entities (also referred to as RLC bearers) to be configured for a DRB. When duplication is used, the UE may be configured with N (wherein N may be up to 4 in Release 16, for example) activated RLC entities for the duplication on a DRB, as illustrated in FIG. 1A. However, as illustrated in FIG. 1B, not all of the activated RLC entities may be used for transmission at all times. For example, only the RLC bearers 292A and 292N may be scheduled while the RLC bearers 292B and 292C are not scheduled and therefore not used for PDCP duplication at that given time. In the next scheduling occasion, a different selection of the RLC bearers may be scheduled by the network. And, the amount of RLC bearers used for PDCP packet duplication may vary between each scheduling occasion.

In order to keep the complexity of UE implementation under control, the UE only needs to support a certain maximum number of data radio bearers (DRB) as described in for example 3GPP TS 38.306, Technical Specification, 3rd Generation Partnership Project; Technical Specification Group Radio Access Network; NR; User Equipment (UE) radio access capabilities (Release 15) as well as subsequent versions, hereinafter 3GPP TS 38.306. In Release 15, the maximum number of supported DRBs is 16. At the UE, the quantity of DRB that can be handled at any given time may be limited by at least the UE's memory and processing. For example, memory may be directly linked to the number of PDCP and/or RLC entities that can be established at the UE, and processing limits the total number of logical channels that can be processed at the UE.

A problem exists in how the RLC entities are accounted for to make sure the UE's capabilities with respect to processing and/or memory are not exceeded. For example, 3GPP TS 38.306 currently specifies that when packet duplication is configured at the UE, each additional RLC entity is to be counted as a full DRB due to each RLC entity requiring a separate logical channel ID (which is used to number the DRBs). In other words, an RLC is treated as a full DRB for counting towards the limit or maximum DRBs allowed at the UE. When a DRB is configured with 4 RLC entities for packet duplication for example, the DRB may then be counted as 4 DRBs. However, the handling of 4 RLC entities, for example, serving a single DRB may not be as processing and memory intensive as the handling of 4 RLC entities serving 4 different DRBs, for example because not all RLC entities may be simultaneously used at all times. Moreover, the handling of RLC entities in an acknowledged mode (AM) can require more processing and memory resources at the UE, when compared to handling of the RLC entities in an unacknowledged mode (UM) entities since in RLC AM, the RLC entity performs tasks such as sequence numbering, status reporting (e.g., acknowledgement (ACK) and n-acknowledgement (NACK)), and retransmissions, which are not done in RLC UM mode. Thus, counting an RLC entity as a full DRB does not always precisely reflect to the actual UE capability.

When configured in the UE, the secondary RLC entities (e.g., the ones used for transmitting duplicate data) may be dynamically switched on and off (e.g., activated or deactivated) via network signaling. So, although the RLC entity is configured in the UE, it does not mean that the configured RLC entity is used by the UE at any given time. When an RLC entity is deactivated, it does not use up as much of the UE's memory and processing resources (or uses much less resources at least). If an RLC entity is not deactivated, the data from the logical channel corresponding to the RLC entity is scheduled for transmission via a resource allocation in the lower protocol layer. When a RLC entity is halted, the RLC entity may receive data from the upper layer (e.g., the PDCP), but the data (received from the upper layer and buffered in its corresponding logical channel) may not be allocated to any radio resource. In other words, when the lower layer (e.g., MAC) constructs a data packet based on data from at least one logical channel, the logical channel of a halted RLC entity is omitted, so the lower layer does not fetch any data from this logical channel for transmission. And when an RLC entity is deactivated, the RLC entity does not receive any data or packet from the upper layer (e.g., PDCP).

Moreover, there may be provided a handover, such as a Dual Active Protocol Stack (DAPS) handover developed as part of 3GPP Release 16. The DAPS handover refers to a handover that aims to minimize the user data interruption time during a handover by allowing UE to be remain connected to and scheduled by the source cell while initiating connection to the target cell, and only dropping the source cell connection after the target cell connection is operational. DAPS may allow near zero millisecond interruption time for handovers. During the DAPS handover, each of the UE's DRBs (which is configured with DAPS) may be temporarily associated with two RLC entities, one RLC entity associated with a source cell and the other RLC entity associated with a target cell. The DRBs configured with DAPS may count twice, for example, towards the UE's DRBs limit due to the duplicated processing load over the protocol stacks. Apart from packet duplication and DAPS, additional RLC entities may be configured for other purposes as well. In some example embodiments, there is provided a new UE capability that signals to the network count information regarding the RLC entities the UE is capable of handling for operations such as packet duplication and/or DAPS. For example, the UE may signal to the network (e.g., a base station, gNB, eNB, a core network node, and/or the like) the UE capabilities with respect to the number of RLC entities the UE is capable of handling. This amount may be an additional amount of RLC entities. For example, the UE may signal to the network that the UE is capable of handling 8 additional RLC entities for packet duplication and/or DAPS.

Alternatively, or additionally, an RLC entity (which is configured for packet duplication) may be allowed to be treated as not being a full RLC (or a full DRB) for the purpose of counting towards a maximum number of supported RLCs at the UE. This may allow the UE to handle a larger number of RLC configured for packet duplication and/or DAPS, without exceeding its capability. Whether (or not) the additional RLC entities configured for packet duplication (or DAPS) are fully accounted for (or partially accounted for) as an RLC (or a DRB) may depend on the UE's capability signaled to the network. The capability signaling may indicate how many additional RLC entities (which may not be counted as a full DRB towards a given limit of DRBs at the UE) are supported for duplication. In other words, an additional DRB may not be treated as a full DRB that is counted towards that given limit. For example, the UE may signal to the network a fractional number (e.g., for packet duplication or DAPS 1 RLC entity counts as 0.6 DRBs).

Although some of the examples disclosed herein refer to URLLC, the subject matter disclosed herein may be used in other types of services and applications. And although some of the examples refer to the signaling in the context of RLC entities used for packet duplication, this signaling may also indicate RLC entities configured for DAPS handover.

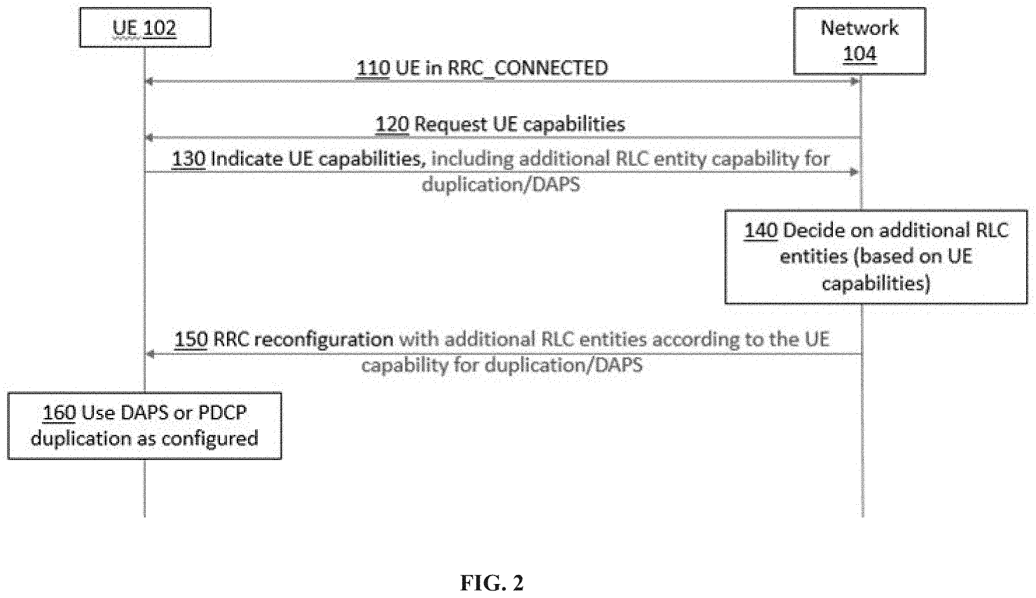

FIG. 2 depicts an example of a signaling flow between a UE 102 and a network 104, in accordance with some example embodiments. The network 104 may comprise a base station, such as an eNB base station, gNB type base station, or other type of network node including core network node.

At 110, the UE 102 may be in a radio resource control connected state with the network 104. At 120, the network may request the UE to provide its capabilities to the network, in accordance with some example embodiments.

At 130, the UE 102 may send to the network 104 its capabilities with respect to any additional RLC entities the UE is willing to handle over a given or theoretical limit at the UE. These additional RLC entities may be for packet duplication and/or DAPS. For example, the UE may indicate to the network the UE's capability regarding how many DRBs the UE supports and how the RLC entities (which are configured for packet duplication or DAPS handover) are counted in terms of a maximum number of DRBs or RLCs which can be handled by the UE.

To illustrate further, the UE may indicate that it supports N additional RLC entities (or N total RLC entities) for packet duplication and/or DAPS handover. The N additional RLC entities may be an additional quantity of RLC entities (which are used for packet duplication and/or DAPS handover) that the UE is able to support. For example, this additional quantity N may be 8 indicating that the UE is able to support 8 additional RLCs (e.g., a limit imposed based on the UE's capability, a standard, and/or the like) on top of the number of full DRBs the UE can support. The UE may signal the network that the UE can support 8 additional RLC entities, for example, although the UE already has all 16 DRBs configured, for example (so the UE may have 16 full DRBs and 24 RLC entities distributed among these 16 full DRBs, where a full DRB may be configured with 2 or more RLC entities.)

At 140, the network may decide on a number of additional RLC entities (based on UE capabilities), in accordance with some example embodiments. The quality of additional RLC entities may be determined based on the UE's capabilities indicated at 130. And, the additional RLC entities may be used for packet duplication and/or a DAPS handover), in accordance with some example embodiments. For example, if the UE is able to handle 8 additional RLC entities, the network may proceed with the packet duplication configuration at the UE (and network) based on these 8 additional RLC entities. In this example, the network may establish 8 additional RLC entities with the UE for packet duplication.

At 150, the network 104 may respond with an RRC reconfiguration including the additional RLC entities which may be used for PDCP packet duplication (or for the DAPS handover), in accordance with some example embodiments. This re-configuration may include DRBs with multiple RLC entities (which are configured with duplication and/or DAPS), in accordance to UE capability indicated at 130.

At 160, the UE may implement the packet duplication (or DAPS handover) as configured by the network at 150. In other words, the UE may configure itself to support the additional RLCs per the networks configuration.

In some embodiments, the UE may signal, at 130, to the network one or more of the factors 1-9 noted below. Whether an additional RLC entity at the UE is counted by a UE as a DRB may depend on one or more of a combination of the following factors:
1. Some UEs may not restrict the number of additional RLC UM entities configured for duplication. For example, the number of additional RLC UM entities configured for packet duplication may not affect the total number of DRBs allowed at the UE.
2. Some UEs may allow up to N additional RLC UM entities to be configured without decreasing the total number of DRBs.
3. Some UEs may not restrict the number of additional RLC AM entities configured for duplication. For example, the number of additional RLC AM entities configured for duplication would not affect the total number of DRBs.
4. Some UEs may allow up to N additional RLC AM entities to be configured without decreasing the total number of DRBs.
5. Some UEs may not restrict the number of additional RLC entities configured while performing dual active protocol stack handover. For example, the DRBs configured with dual active protocol stack would not count as multiple DRBs due to DAPS.
6. Some UEs may allow up to N additional RLC entities to be configured in the UE while preforming dual active protocol stack handover without decreasing the total number of DRBs.
7. Some UEs may not restrict the number of additional deactivated RLC entities configured for duplication. For example, the RLC entities configured for packet duplication would not affect the total number of DRBs for as long as they remain deactivated.
8. Some UEs may allow up to N additional non-active RLC entities to be configured in the UE without decreasing the total number of DRBs.
9. Any combination of the above for RLC AM, RLC UM, non-active RLC entities and RLC entities for DAPS handover may be implemented as well.

In some example embodiments, there may be provided a new UE capability information that indicates to the network that the UE allows more RLC entities (for DAPS and/or packet duplication) than theoretically allowed by the DRB capability. As the UE may have more RLC entities than theoretically allowed, there may be provided logical channel halting upon configuration of RLC entities exceeding the limit that are theoretically allowed (e.g., given the UE's capability, a standard, etc.) by the UE's DRB capability. For example, the UE may allow itself to be configured with more RLC entities for duplication and/or DAPS handover (or any other purposes) than allowed by the UE's DRB or RLC entity capability (when considering each additional RLC entity as full additional DRB, for example). With such a configuration, the UE may be allowed to halt processing of any excess RLC entities. For example, the UE may allow to be configured with N RLC entities, which may be additional RLC entities (more than allowed), but the UE may allow to have only a certain quantity of RLC entities active and/or scheduled for transmission at any given time (e.g., the same, similar, or overlapping times).

To illustrate further, some of the RLC entities may not be active (e.g., configured but not being scheduled for transmission by the lower layer, or configured but not receiving data from the higher layer), and these inactive RLC entities may not be as memory and processor intensive as active RLC entities that are actively transmitting (or scheduled for transmission). As noted with respect to FIG. 2A, the PDCP PDU 290 includes N RLC bearers 292A-N, while FIG. 2B depicts the same PDCP 290 but shows that RLC entities 292A and 292N are actively scheduled for transmission, while RLC entities 292B and 292C are inactive for transmission.

In some embodiments, the UE may signal to the network two separate UE capabilities. The first UE capability may indicate the number of RLC entities which can be served by the UE, with guarantees (e.g., a service guarantee that these RLC entities can always be active and/or transmitting at the same time).

The second UE capability may indicate the number of additional RLC entities which can be configured in the UE (but without guarantee that all the RLC entities can always be active and/or transmitting at the same time). When this is the case, for DRBs configured with multiple RLC entities for duplication, the UE may autonomously bypass some transmission opportunities (e.g., uplink grants) scheduled on the serving cells mapping for certain logical channels (LCHs) corresponding to certain RLC entities. For example, the transmission from certain logical channels under a DRB may be halted to ensure the total number of RLC entities in transmission is within the limit. Alternatively, or additionally, the UE may autonomously deactivate some RLC entities, so the higher layer does not even submit packets to these deactivated RLC entities. The selection of logical channels to be halted or RLC entities to be deactivated may be (1) a UE implementation choice, (2) fixed by specification (e.g. according to logical channel prioritization (LCP)), (3) pre-configured by the network, or a combination thereof.

The UE may apply a selection rule to select logical channels and/or RLC entities to be halted or deactivated. The selection rule being applied may depend on factors such as how many RLC entities are configured in excess of UE capabilities for full DRBs, battery status of the UE, mobility state of the UE, data traffic patterns (or characteristics) of the UE, and the like.

Moreover, apart from “halting” the logical channels noted above, another alternative is that the UE may “de-activate” the RLC entities autonomously in cases of excessive configuration, and the selection rules noted herein may still be applicable for selecting the RLC entities to be deactivated. Regarding halting, the PDCP may still submit PDCP PDUs to the halted RLC entities even though MAC will omit its data when performing logical channel prioritization (LCP). With deactivation, the PDCP does not even submit PDUs to the deactivated RLC entities.

When the network configures more RLC entities than allowed for a UE, the UE may select the RLC entities (and the corresponding logical channels) to be halted or deactivated by one or combination of some of the following criteria:
1. The RLC entities associating to at least one DRB mapped to QoS flows with a subset of QoS flow identifier (QFI). For example, the RLC entity may carry a QoS flow which belongs to a subset of QoS flows. The QoS flow is identified by a QFI and mapping onto a DRB/logical channel happens in SDAP (see, e.g., 3GPP TS37.324)]
2. The operational mode of RLC. For example, RLC entities with AM or UM should be halted.
3. The RLC entities whose corresponding logical channels are mapping to serving cells in certain frequency range (e.g., FR2, unlicensed band) or cell groups.
4. The RLC entities whose corresponding logical channels are mapped to serving cells having the worst instantaneous radio channel quality.
5. The RLC entities whose corresponding logical channels configured with certain mapping restrictions such as subcarrier spacing, PUSCH duration, grant type, and/or grant priority/configurations.
6. The logical channel prioritization parameters of the corresponding logical channels, such as LCH priority, prioritized bit rate (PBR), and bucket size duration (BSD).
7. RLC entities associating to DRBs with highest/lowest index.
8. The RLC entities whose corresponding logical channels with highest/lowest index (see, e.g., TS 38.321 and/or 38.331 describing logical channel IDs and indexes).
9. The RLC entities that are processing PDCP PDUs with highest or lowest PDCP sequence number (SN) (see, e.g., TS 38.323 describing PDCP SNs).
10. The RLC entities according to order of a network-configured priority indicator (e.g., an integer number from high to low or low to high).
11. The RLC entities that were configured for DAPS handover.
12. The RLC entities that were configured for packet duplication.
13. The RLC entities that were configured for master cell group or secondary cell group (assuming the UE has dual-connectivity to two different base stations).

The criteria 1-13 above to be applied at the UE may be configured by the base station, defined by a standard or specification, and/or determined by the UE itself.

When configuring an RLC entity, the network may include an indication of priority for the RLC entity. Furthermore, the UE may determine which RLC entities should be halted based on the indicated priority value.

In some example embodiments, the UE may cyclically switch the logical channels/RLC entities to be halted or deactivated (e.g., similarly as logical channel prioritization operates via token bucket). This may be beneficial in terms of averaging out impacts of occasional “flash” on the radio channel (assuming LCH mapping restriction has been configured such that data from each logical channel can only be mapped to resources in specific set of serving cells), such as interference or blockage and ensuring the overall processing limit is not exceeded. The cyclical switch of logical channels may be implemented by for example configuring a timer that starts whenever the UE begins to halt at least one logical channel. Upon timer expiration, the UE may switch the logical channels that are being halted, and the timer me be reset or restart. This procedure may repeat until the total number of configured RLC entities is once again below the processing limit of the UE. The ordering of cyclically switch may be pre-configured, based on the priority levels of RLC entities, the index of RLC entities, or any other characteristics relating to configuration of RLC entities.

To assist the base station (e.g., a gNB type base station and the like), the UE may send an indication of whether the processing limit has been reached. This indication may be provided as a MAC control element, a buffer status report, an RLC or PDCP status report, a bit within a MAC/RLC/PDCP protocol header, an indication in an RRC message or in some other form of UE reporting or signaling to the network. This reporting or signaling may include at least an indication that the processing limit has been reached or provide details as to which logical channel, RLC entities, DRB, or QoS flow cannot be processed, is being halted, deactivated, or is de-prioritized.

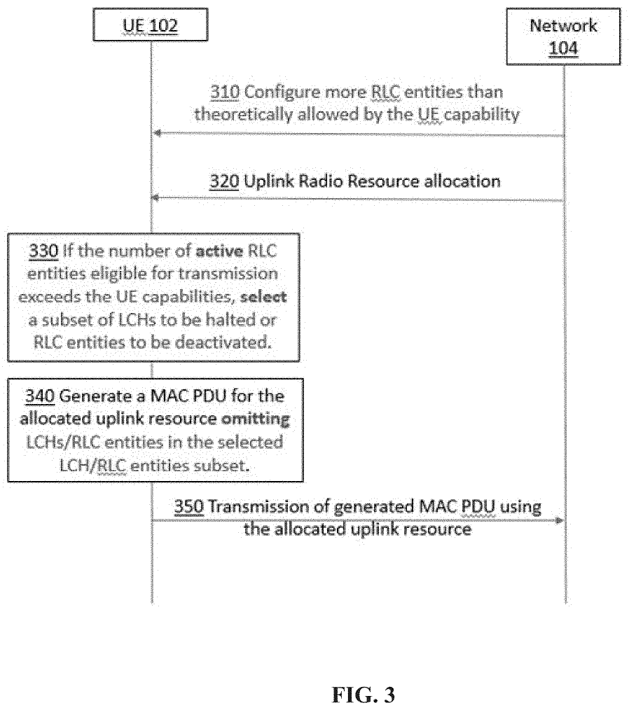

FIG. 3 depicts another example of a signaling flow between the UE 102 and the network 104, in accordance with some example embodiments.

At 310, the network 104 may configure the UE 102 with more RLC entities than theoretically allowed by the UE's capability. For example, the UE may have a capability to handle 16 RLC entities for instance according to the maximum number of DRBs, but the network may configure 20 additional LC entities at the UE.

At 320, the network 104 may provide to the UE an uplink radio resource allocation. For example, the network may provide an uplink radio resource allocation for the RLC entities. This radio resource allocation may determine whether a given RLC entity is scheduled for a transmission. For example, the allocation may schedule RLC entities 292A and 292N, while RLC entities 292B and 292C are inactive.

At 330, if the number of active RLC entities eligible for transmission exceeds the UE capabilities, the UE 102 may select a subset of RLC entities (or their corresponding logical channels) to be halted or RLC entities to be deactivated. Referring to the previous example, the allocation may activate 2 RLC entities 292A and 292N for transmission, but this may be too many for the UE to handle in which case the UE may need to select one or more RLC entities to halt.

At 340, the UE 102 may generate data, such as a MAC PDU, for the allocated uplink resource, but the UE may omit RLC entities (or their logical channel IDs) selected to be halted. For example, the UE 102 may signal to the network 104 the RLC entities (or logical channels being halted) by not including them in the generated MAC PDU sent, at 350, to the network 104, so the network knows which RLC entities are being halted (or deactivated). At 350, the MAC PDUs (which are generated at 340) are transmitted to the network using the allocated uplink resource, in accordance with some example embodiments.

A mix of the two approaches of FIGS. 2 and 3 may be implemented as well to allow up to N additional RLC UM entities to be configured, without decreasing the total number of DRBs while leaving the UE behavior unspecified when the total number of DRBs to be transmitted at the same time exceeds a limit of 16+N, for example.

The process depicted at FIG. 2 would correctly reflect the fact that an RLC UM entity may not consume as much memory and processing resource as other types of RLC entities, such as an RLC AM entity. And, the process of FIG. 2 may allow more advanced implementation to support more DRBs with duplication configured without having to support full DRBs. The process depicted at FIG. 3 would target less flexible UEs and rely on not using duplication on all DRBs on the largest possible number of RLC entities to allow more flexible configurations. The process depicted at FIG. 3 would also allow the gNB base station to take advantage of the additional RLC entities as long as the related data is not scheduled for UE transmission at the same time for all of them.

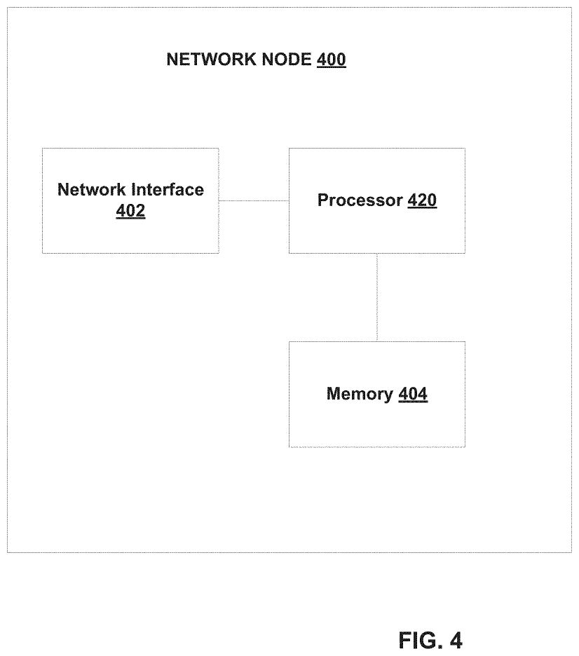

FIG. 4 depicts an example of a network node 400, in accordance with some example embodiments. In some example embodiments, the network node 400 may be implemented to provide a base station, such as an eNB, gNB, or other type of network node as well as a core network node.

In some example embodiments, the network node 400 implements the process disclosed herein with respect to the network 104 (see, e.g., FIGS. 2 and 3). The network node 400 may include a network interface 402, at least one processor 420, and at least one memory 404, in accordance with some example embodiments. The network interface 402 may include wired and/or wireless transceivers to enable access other nodes including base stations, a data network such as the Internet, core network nodes, and/or other nodes. The memory 404 may comprise volatile and/or non-volatile memory including program code, which when executed by at least one processor 420 provides, among other things, the processes disclosed herein with respect to the network node.

In some example embodiments, the network node may receive capability information including an indication of a user equipment being able to be configured with at least one additional radio link control entity that is not accounted for fully or partially towards a limit for the user equipment's capability for data radio bearers or for radio link control entities. And, the network node may operate at least one additional radio link control entity, the at least one additional radio link control entity exceeding a limit for the user equipment's capability for data radio bearers or for radio link control entities.

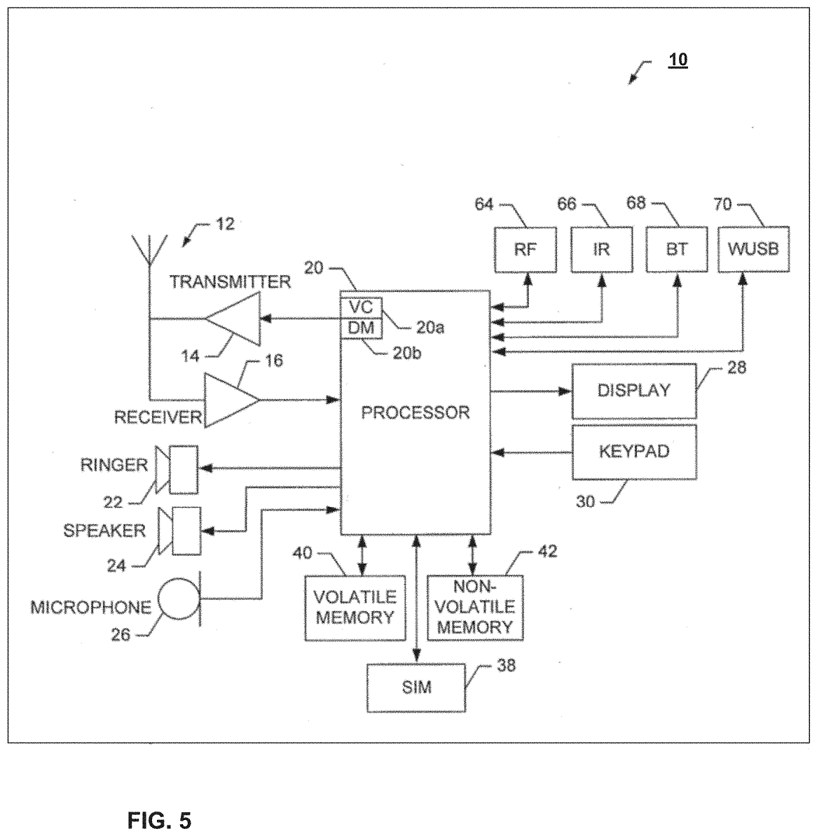

FIG. 5 illustrates a block diagram of an apparatus 10, in accordance with some example embodiments.

The apparatus 10 may represent a user equipment, such as the user equipment 150.

The apparatus 10 may include at least one antenna 12 in communication with a transmitter 14 and a receiver 16. Alternatively transmit and receive antennas may be separate. The apparatus 10 may also include a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise, processor 20 may be configured to control other elements of apparatus 10 by effecting control signaling via electrical leads connecting processor 20 to the other elements, such as a display or a memory. The processor 20 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Accordingly, although illustrated in FIG. 5 as a single processor, in some example embodiments the processor 20 may comprise a plurality of processors or processing cores.

The apparatus 10 may be capable of operating with one or more air interface standards, communication protocols, modulation types, access types, and/or the like. Signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques, such as Institute of Electrical and Electronics Engineers (IEEE) 802.11, 802.16, 802.3, ADSL, DOCSIS, and/or the like. In addition, these signals may include speech data, user generated data, user requested data, and/or the like.

For example, the apparatus 10 and/or a cellular modem therein may be capable of operating in accordance with various first generation (1G) communication protocols, second generation (2G or 2.5G) communication protocols, third-generation (3G) communication protocols, fourth-generation (4G) communication protocols, fifth-generation (5G) communication protocols, Internet Protocol Multimedia Subsystem (IMS) communication protocols (for example, session initiation protocol (SIP) and/or the like. For example, the apparatus 10 may be capable of operating in accordance with 2G wireless communication protocols IS-136, Time Division Multiple Access TDMA, Global System for Mobile communications, GSM, IS-95, Code Division Multiple Access, CDMA, and/or the like. In addition, for example, the apparatus 10 may be capable of operating in accordance with 2.5G wireless communication protocols General Packet Radio Service (GPRS), Enhanced Data GSM Environment (EDGE), and/or the like. Further, for example, the apparatus 10 may be capable of operating in accordance with 3G wireless communication protocols, such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus 10 may be additionally capable of operating in accordance with 3.9G wireless communication protocols, such as Long Term Evolution (LTE), Evolved Universal Terrestrial Radio Access Network (E-UTRAN), and/or the like. Additionally, for example, the apparatus 10 may be capable of operating in accordance with 4G wireless communication protocols, such as LTE Advanced, 5G, and/or the like as well as similar wireless communication protocols that may be subsequently developed.

It is understood that the processor 20 may include circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the apparatus 10 may be allocated between these devices according to their respective capabilities. The processor 20 may additionally comprise an internal voice coder (VC) 20a, an internal data modem (DM) 20b, and/or the like. Further, the processor 20 may include functionality to operate one or more software programs, which may be stored in memory. In general, processor 20 and stored software instructions may be configured to cause apparatus 10 to perform actions. For example, processor 20 may be capable of operating a connectivity program, such as a web browser. The connectivity program may allow the apparatus 10 to transmit and receive web content, such as location-based content, according to a protocol, such as wireless application protocol, WAP, hypertext transfer protocol, HTTP, and/or the like.

Apparatus 10 may also comprise a user interface including, for example, an earphone or speaker 24, a ringer 22, a microphone 26, a display 28, a user input interface, and/or the like, which may be operationally coupled to the processor 20. The display 28 may, as noted above, include a touch sensitive display, where a user may touch and/or gesture to make selections, enter values, and/or the like. The processor 20 may also include user interface circuitry configured to control at least some functions of one or more elements of the user interface, such as the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. The apparatus 10 may include a battery for powering various circuits related to the mobile terminal, for example, a circuit to provide mechanical vibration as a detectable output. The user input interface may comprise devices allowing the apparatus 20 to receive data, such as a keypad 30 (which can be a virtual keyboard presented on display 28 or an externally coupled keyboard) and/or other input devices.

As shown in FIG. 5, apparatus 10 may also include one or more mechanisms for sharing and/or obtaining data. For example, the apparatus 10 may include a short-range radio frequency (RF) transceiver and/or interrogator 64, so data may be shared with and/or obtained from electronic devices in accordance with RF techniques. The apparatus 10 may include other short-range transceivers, such as an infrared (IR) transceiver 66, a Bluetooth™ (BT) transceiver 68 operating using Bluetooth™ wireless technology, a wireless universal serial bus (USB) transceiver 70, a Bluetooth™ Low Energy transceiver, a ZigBee transceiver, an ANT transceiver, a cellular device-to-device transceiver, a wireless local area link transceiver, and/or any other short-range radio technology. Apparatus 10 and, in particular, the short-range transceiver may be capable of transmitting data to and/or receiving data from electronic devices within the proximity of the apparatus, such as within 10 meters, for example. The apparatus 10 including the Wi-Fi or wireless local area networking modem may also be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The apparatus 10 may comprise memory, such as a subscriber identity module (SIM) 38, a removable user identity module (R-UIM), an eUICC, an UICC, and/or the like, which may store information elements related to a mobile subscriber. In addition to the SIM, the apparatus 10 may include other removable and/or fixed memory. The apparatus 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing operations disclosed herein including operating, by a user equipment, at least one additional radio link control entity, the at least one additional radio link control entity exceeding a limit for the user equipment's capability for data radio bearers or for radio link control entities; and stopping, by the user equipment, use of the at least one additional radio link control entity.

The memories may comprise an identifier, such as an international mobile equipment identification (IMEI) code, capable of uniquely identifying apparatus 10. The memories may comprise an identifier, such as an international mobile equipment identification (IMEI) code, capable of uniquely identifying apparatus 10. In the example embodiment, the processor 20 may be configured using computer code stored at memory 40 and/or 42 to control and/or provide one or more aspects disclosed herein including generating, by a user equipment, capability information including an indication of the user equipment being able to be configured with additional radio link control entities that are not accounted for fully or partially towards a limit for the user equipment's capability for data radio bearers or for radio link control entities and sending, by the user equipment, the capability information including the indication to a base station.

Some of the embodiments disclosed herein may be implemented in software, hardware, application logic, or a combination of software, hardware, and application logic. The software, application logic, and/or hardware may reside on memory 40, the control apparatus 20, or electronic components, for example. In some example embodiment, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as a computer or data processor circuitry, with examples depicted at FIG. 5, computer-readable medium may comprise a non-transitory computer-readable storage medium that may be any media that can contain or store the instructions for use by or in connection with an instruction execution system, apparatus, or device, such as a computer.

Without in any way limiting the scope, interpretation, or application of the claims appearing below, a technical effect of one or more of the example embodiments disclosed herein may be enhanced use of a UE's capabilities.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “computer-readable medium” refers to any computer program product, machine-readable medium, computer-readable storage medium, apparatus and/or device (for example, magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, the implementations described above may be directed to various combinations and subcombinations of the disclosed features and/or combinations and subcombinations of several further features disclosed above. Other embodiments may be within the scope of the following claims.

If desired, the different functions discussed herein may be performed in a different order and/or concurrently with each other. Furthermore, if desired, one or more of the above-described functions may be optional or may be combined. Although various aspects of some of the embodiments are set out in the independent claims, other aspects of some of the embodiments comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of some of the embodiments as defined in the appended claims. Other embodiments may be within the scope of the following claims. The term “based on” includes “based on at least.” The use of the phase “such as” means “such as for example” unless otherwise indicated.

What is claimed:

1. A method comprising:
generating, by a user equipment, capability information including an indication of the user equipment being able to be configured with additional radio link control entities that are not accounted for fully or partially towards a limit for the user equipment's capability for data radio bearers or for radio link control entities; and
sending, by the user equipment, the capability information including the indication to a base station.

2. The method of claim 1, wherein the additional radio link control entities are for packet duplication and/or a handover.

3. The method of claim 2 further comprising:
receiving, by the user equipment, a configuration for an additional quantity of radio link control entities exceeding the limit.

4. The method of claim 3, wherein the indication includes information that radio link control entities are not counted, or are partially counted, towards the limit, when the radio link control entities are in a deactivated state or have not been scheduled for transmission.

5. An apparatus comprising:
at least one processor; and
at least one memory including computer program code, the at least one memory and the computer program code configured to, with the at least one processor, cause the apparatus to at least:
generate capability information including an indication of the apparatus being able to be configured with additional radio link control entities that are not accounted for fully or partially towards a limit for the apparatus's capability for data radio bearers or for radio link control entities; and
send the capability information including the indication to a base station.

6. The apparatus of claim 5, wherein the additional radio link control entities are for packet duplication and/or a handover.

7. The apparatus of claim 6, wherein the apparatus is further caused to at least receive a configuration for an additional quantity of radio link control entities exceeding the limit.

8. The apparatus of claim 7, wherein the indication includes information that radio link control entities are not counted, or are partially counted, towards the limit, when the radio link control entities are in a deactivated state or have not been scheduled for transmission.

9. An apparatus comprising:
at least one processor; and
at least one memory including computer program code, the at least one memory and the computer program code configured to, with the at least one processor, cause the apparatus to at least:
operate at least one additional radio link control entity, the at least one additional radio link control entity exceeding a limit for the apparatus's capability for data radio bearers or for radio link control entities; and
stop use of the at least one additional radio link control entity.

10. The apparatus of claim 9, wherein the stopping of the use comprises halting a logical channel mapped to the at least one additional radio link control entity, and/or wherein the stopping of the use comprises deactivating the at least one additional radio link control entity.

11. The apparatus of claim 10, wherein the apparatus is further caused to at least send a first apparatus capability indicating a first quantity of radio link control entities that the apparatus may configure with a service guarantee.

12. The apparatus of claim 11, wherein the apparatus is further caused to at least send a second apparatus capability indicating a second quantity of radio link control entities that the apparatus may configure without the service guarantee such that the apparatus is allowed to halt or deactivate the at least one additional radio link control entity, the second quantity of radio link control entities including the at least one additional radio link control entity.

13. The apparatus of claim 12, wherein the apparatus is further caused to at least configure the second quantity of radio link control entities including the at least one additional radio link control entity.

14. The apparatus of claim 13, wherein the second quantity of radio link control entities are used for packet duplication and/or a handover.

15. The apparatus of claim 14, wherein the at least one additional radio link control entity is halted or deactivated based on a selection rule.

16. The apparatus of claim 15, wherein the selection rule is based on one or more of the following factors: the at least one additional radio link control entity being associated to at least one data radio bearer mapped to a QoS flow with a QoS flow identifier; a mode of the at least one additional radio link control entity; the at least one additional radio link control entity having a logical channel mapping to a serving cell in a frequency range or a cell group; an instantaneous radio channel quality of a serving cell for the logical channel mapped to the at least one additional radio link control entity; a mapping restriction for a logical channel mapped to the at least one additional radio link control entity; an index; and a sequence number.

17. The apparatus of claim 16, wherein the selection rule is based on a priority of the at least one additional radio link control entity.

18. The apparatus of claim 17, wherein the selection rule is based on switching among a plurality of the radio link control entities.

19. The apparatus of claim 18, wherein the selection rule is configured by a base station.

20. The apparatus of claim 19, wherein the apparatus is further caused to at least send a report to the network, the report indicating whether the limit has been reached.
